(19) United States
(12) Patent Application Publication
(10) Pub. No.: US 2010/0146399 A1
(43) Pub. Date: Jun. 10, 2010

(54) METHOD, APPARATUS AND SYSTEM FOR MODIFYING WEBSITE FLOW STACK TO MANAGE SITE-WIDE CONFIGURATION

(76) Inventors: Charles Laurence STINSON, Mississauga (CA); Sang-Heun KIM, Mississauga (CA); Martyn Henri MALLICK, Waterloo (CA)

Correspondence Address: PERRY + CURRIER INC.;(FOR RIM), 1300 YONGE STREET, SUITE 500, TORONTO, ON, M4T-1X3, CA

(21) Appl. No.: 12/414,094

(22) Filed: Mar. 30, 2009

Related U.S. Application Data
(60) Provisional application No. 61/120,960, filed on Dec. 9, 2008.

(51) Int. Cl. G06F 15/177; G06F 3/01

(52) U.S. Cl. 715/744; 709/220

(57) ABSTRACT

A method, apparatus and method for modifying website flow stack to manage site-wide configuration are provided. In one embodiment a client machine is configured to accesses a website and to extract configuration options from programming instructions embedded in the website. The client machine is further configured to generate the configuration options using a second set of programming instructions, and to receive a selection of the configuration options. The client machine is further configured to directly receive web pages from the website that are specific to the selected configuration options.

### CROSS REFERENCE TO RELATED APPLICATION

The present specification claims priority to U.S. Provisional Patent Application 61/120,960 filed Dec. 9, 2008, the contents of which are incorporated herein by reference.

### FIELD

The present specification relates generally to communication technologies and more particularly to a method, apparatus and system for modifying website flow stack to manage site-wide configuration.

### BACKGROUND

Desktop-focused websites often have plurality of configuration options such as language, text size, time zone, etc. Input for establishing configuration options are often provided as part of a fillable form or other interactive component, as part of overall rendering of an entire webpage. In other contexts configuration options are established during a membership sign-up process.

Once configurations options are set, the web-server utilizes the stored settings to customize browsing experience based on those configuration options. For example, on the existing ticketmaster.com website, a locale can be set. Changing the locale causes the home page to render so as to display events that are proximal to the locale. Tvguide.com has similar settings, which cause changes to the displayed television listings according to locale.

### BRIEF DESCRIPTION OF THE DRAWINGS

FIG. 1 is schematic representation of a system for modifying website flow stack to manage site-wide configuration.

FIG. 2 is a schematic representation of the client machine computing device in FIG. 1.

FIG. 3 shows a flow-chart depicting a method for modifying website flow stack to manage site-wide configuration.

FIG. 4 shows an example of a web page stored on the web server in the system of FIG. 1.

FIG. 5 shows an example of another web page stored on the web server in the system of FIG. 1.

FIG. 6 shows an example of another web page stored on the web server in the system of FIG. 1.

FIG. 7 shows the system of FIG. 1 during exemplary performance of certain blocks in the method of FIG. 3.

FIG. 8 shows an example of the configuration options extracted from the website of FIG. 1 and generated on the display of the client machine of FIG. 1 using programming instructions native to the client machine of FIG. 1.

FIG. 9 shows the web page of FIG. 5 as generated on the display of the client machine of FIG. 1.

FIG. 10 shows an example of extracted configuration options as one exemplary alternative to the extracted configuration options of FIG. 8.

### DETAILED DESCRIPTION OF THE EMBODIMENTS

An aspect of the specification provides a method of providing interactive content on a portable computing device, the method comprising accessing a website from a server; the website including a first set of configuration option programming instructions; extracting configuration options from the first set of configuration option programming instructions; generating the configuration options using a second set of configuration option programming instructions; receiving a configuration option selection using the second set of configuration option programming instructions; receiving one or more web pages from the website corresponding to the configuration option selection; and, generating the one or more web pages.

The configuration options can include at least one of a locale, language, how many items to display, whether or not to show images or not, color of links.

The method can further comprise receiving a schema and performing the extracting based on the schema. The schema can be received from a schema server separate from the web server. The schema can be received from the web-server.

The first set of programming instructions may comprise scripts. The scripts may be one of Javascripts or dynamic hypertext markup language. The scripts may not be stored locally on said portable computing device.

Another aspect of the specification provides a portable computing device comprising storage configured to maintain a web browser application and at least one processor connected to the storage and configured to execute the web browser application. The portable computing device also comprises an interface connected to the processor The processor is configured to access a website at a web-server via the interface. The website includes a first set of configuration option programming instructions. The processor is further configured to extract configuration options from the first set of configuration option programming instructions. The portable computing device further comprises a display connected to the processor. The processor is further configured to generate the configuration options using a second set of configuration option programming instructions. The portable computing device further comprises an input device connected to the processor. The processor is also configured to receive a configuration option selection using the second set of configuration option programming instructions via the input device. The processor is also configured to receive one or more web pages from the website corresponding to the configuration option selection. The processor is also configured to generate the one or more web pages on the display via the web browser application.

Another aspect of the specification provides a computer readable storage medium configured to maintain a plurality of programming instructions for a processor of a portable computing device. The processor of the portable computing device is configured to execute the programming instructions. The programming instructions comprise the method of: accessing a website from a server; the website including a first set of configuration option programming instructions; extracting configuration options from the first set of configuration option programming instructions; generating the configuration options using a second set of configuration option programming instructions; receiving a configuration option selection using the second set of configuration option programming instructions; receiving one or more web pages from the website corresponding to the configuration option selection; and, generating the one or more web pages.

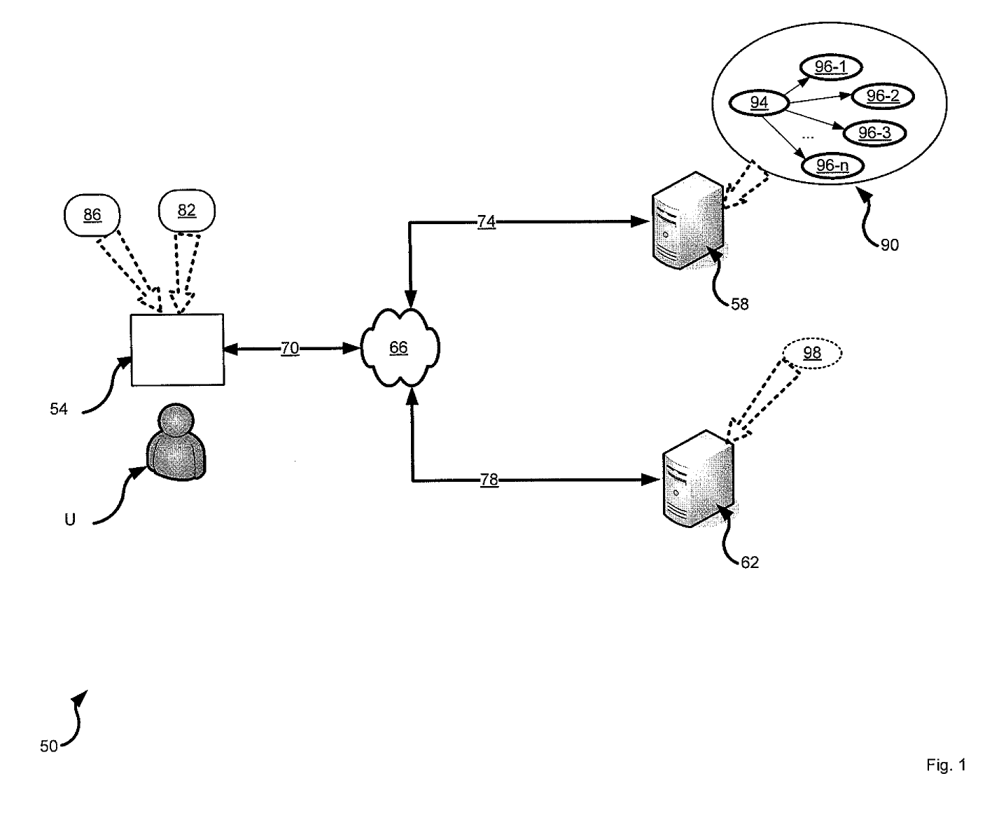

Referring to FIG. 1, a system for providing interactive content on a computing device is indicated generally at 50. In a present embodiment system 50 comprises a first computing device in the form of a client machine 54 and a second computing device in the form of a web server 58, and a third computing device in the form of a schema server 62. In a present embodiment client machine 54 comprises a portable computing device. A network 66 interconnects each of the foregoing components. A first link 70 interconnects client machine 54 and network 66. A second link 74 interconnects server 58 and network 66. A third link interconnects server 62 and network 66.

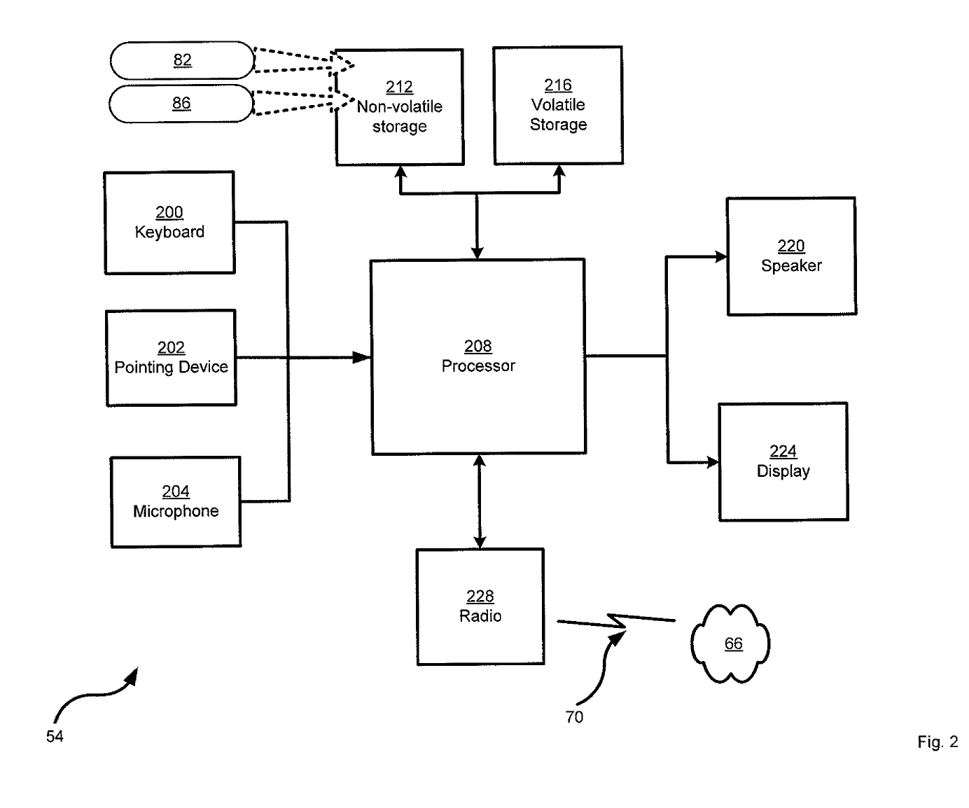

Referring briefly to FIG. 2, a schematic block diagram shows client machine 54 in greater detail. It should be emphasized that the structure in FIG. 2 is purely exemplary, and contemplates a device that can be used for both wireless voice (e.g. telephony) and wireless data (e.g. email, web browsing, text) communications. (Note that various functionalities such as the voice functionality, email functionality, etc. are optional). Client machine 54 includes a plurality of input devices which in a present embodiment includes a keyboard 200, a pointing device 202 (e.g. a trackwheel, a trackball, or a touch screen) and a microphone 204. Other input devices, such as a camera may optionally be contemplated. Input from keyboard 200 and microphone 204 is received at a processor 208, which in turn communicates with a non-volatile storage unit 212 (e.g. read only memory (“ROM”), Erasable Electronic Programmable Read Only Memory (“EEPROM”), Flash Memory) and a volatile storage unit 216 (e.g. random access memory (“RAM”)). It will now be understood by those skilled in the art that non-volatile storage unit 212 and volatile storage unit 216 are non-limiting examples of computer readable storage media. Other examples of computer readable storage media include a removable storage card that can be received in a removable storage card reader that is incorporated into client machine 54 (not shown).

Programming instructions that implement the functional teachings of client machine 54 as described herein are typically maintained, persistently, in non-volatile storage unit 212 and used by processor 208 which utilizes volatile storage 216 during the execution of such programming instructions. Of particular note is that non-volatile storage unit 212 persistently maintains a web browser application 82 and a cache 86. Web browser application 82 can be executed on processor 208 making use of volatile storage 216 as appropriate. Cache 86 can be accessed by processor 208 as needed, keeping copies of cache 86 on volatile storage 216 as needed. Various other applications (not shown) are maintained in non-volatile storage unit 212 according to the desired configuration and functioning of client machine 54.

Web browser application 82 is configured to provide basic web browser functionality on client-machine 54. Web browser application 82 can be referred to as a mini-browser, in the sense that it is provided on client machine 54 which itself has a form factor that is “miniaturized”, at least in relation to the form factor of a desktop computer. As will be explained further below, web browser application 82 is configured to render web pages on the relatively small display of client machine 54, and during such rendering attempt to render those pages in a format that conveys data, as much as possible, substantially in the same manner as if those web pages had been rendered on a full browser such as Internet Explorer® (from Microsoft Corporation, One Microsoft Way, Redmond, Wash.) or Firefox® (from Mozilla Foundation, 1981 Landings Drive, Building K, Mountain View, Calif. 94043-0801, USA.) on a traditional desktop or laptop computer. Web browser application 82 thus provides basic HTML and other web-browsing capability, such as Java script, although subject to features provided herein which can obviate or reduce the need for use of Java script and thereby reduce stresses on the computing resources of client machine 54. Furthermore, even though web browser application 82 is able to execute scripts, certain scripts may be too large to maintain within the constrained storage on client machine 54 and thus client machine 54 may need to temporarily download certain scripts in order to run them, and then delete those scripts once execution is complete. In general, client machine 54 is configured to interact with content available over network 66, including web content on web server 58 via web browser application 82.

Returning again to FIG. 1, web server 58 is configured to host a website 90 that includes, in a present embodiment, programming instructions representing configuration options 94. Website 90 also comprises a first at least one web page 96-1 that corresponds with a first configuration option associated with configurations options 94, a second at least one web page 96-2 that corresponds with a second configuration option associated with configuration options 94, and a third at least one web page 96-3 that corresponds with a third configuration option associated with configuration options 94. One or more additional web pages can also be provided, indicated in the Figures as web pages 96-n, each of which can also correspond with one or more respective additional configuration options associated with configuration options 94. Website 90, including options 94 and web pages 96-1 and web page 96-2, are configured to be accessible via a traditional desktop browser, such as Internet Explorer®, or Firefox®. As will be explained in greater detail below, web browser application 82 is configured to access website 90 and to establish configuration options 94 in a novel manner. Schema server 62 is configured to maintain a web-form schema 98 which can be used by web browser 82 to manage configuration options 94, as will be discussed further below.

Web server 58 and schema server 62 (which can, if desired, be implemented on a single server) can be based on any well-known server environment including a module that houses one or more central processing units, volatile memory (e.g. random access memory), persistent memory (e.g. hard disk devices) and network interfaces to allow servers 58 and 62 to communicate over network 66. For example, server 58 or server 62 or both can be a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for servers 58 and 62 are contemplated.

It should now be understood that the nature of network 66 and the links 70, 74 and 78 associated therewith is not particularly limited and are, in general, based on any combination of architectures that will support interactions between client machine 54 and servers 58 and 62. In a present embodiment network 66 itself includes the Internet as well as appropriate gateways and backhauls to links 70, 74 and 78. Accordingly, the links 70, 74 and 78 between network 66 and the interconnected components are complementary to functional requirements of those components.

More specifically, link 70 between client machine 54 and network 66 can be based in a present embodiment on core mobile network infrastructure (e.g. Global System for Mobile communications (“GSM”); Code Division Multiple Access (“CDMA”); CDMA 2000; 3G; Evolution-Data Optimized (“EV-DO”), Universal Mobile Telecommunications System (“UMTS”), High Speed Packet Access (“HSPA”)) or on wireless local area network (“WLAN”) infrastructures such as the Institute for Electrical and Electronic Engineers (“IEEE”) 802.11 Standard (and its variants) or Bluetooth® or the like or hybrids thereof. Note that in an exemplary variation of system 50 it is contemplated that client machine 54 may be other types of client machines whereby link 70 is a wired connection.

Link 74 may be based on a T1, T3, O3 or any other suitable wired or wireless connection between server 58 and network 66. Link 78 may be based on a T1, T3, O3 or any other suitable wired or wireless connection between server 62 and network 66.

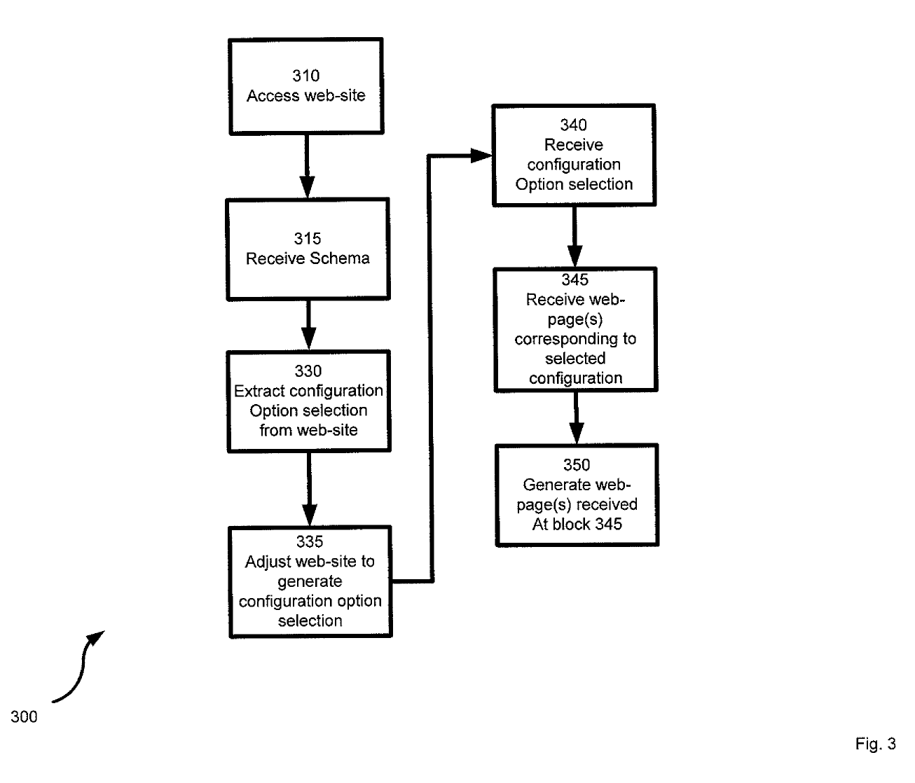

Referring now to FIG. 3, a method for modifying website flow stack to manage site-wide configuration is provided in the form of a flow-chart indicated generally at 300. Method 300 will be explained in conjunction with exemplary performance on system 50, but it should be understood that system 50 and method 300 can both be varied within the scope of the present teachings. For example, the method 300 need not performed in the exact sequence as presented in FIG. 3.

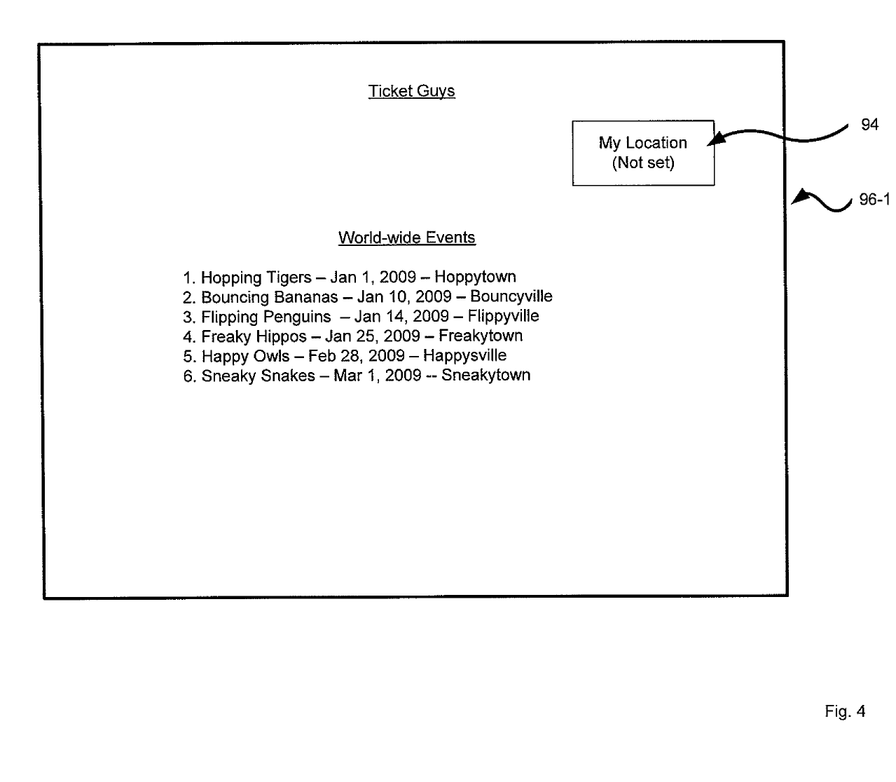

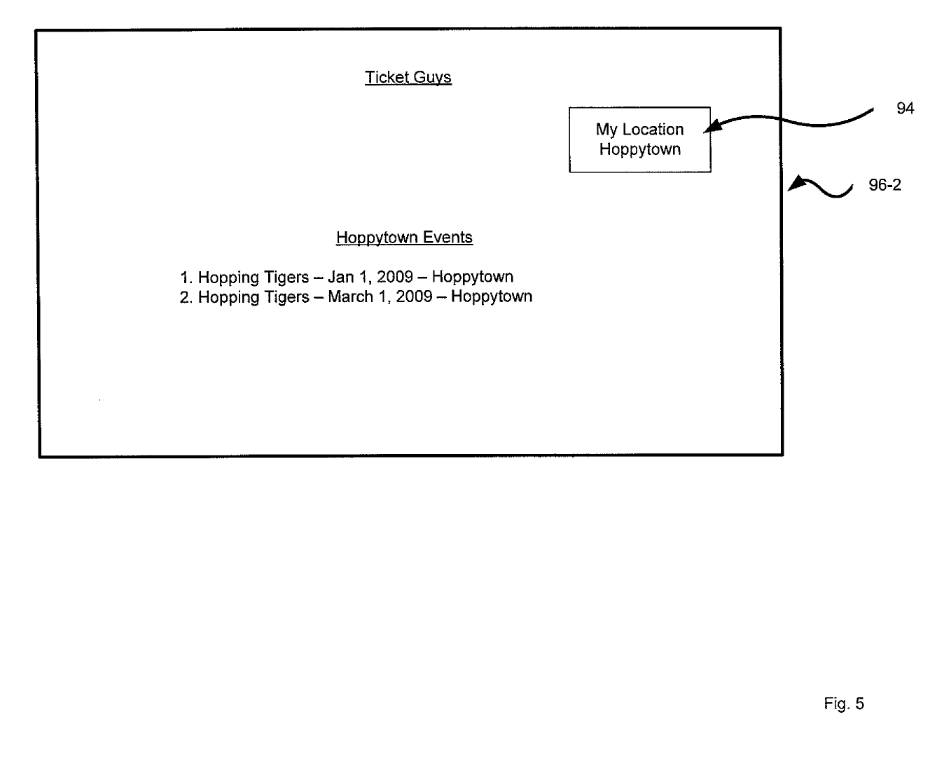

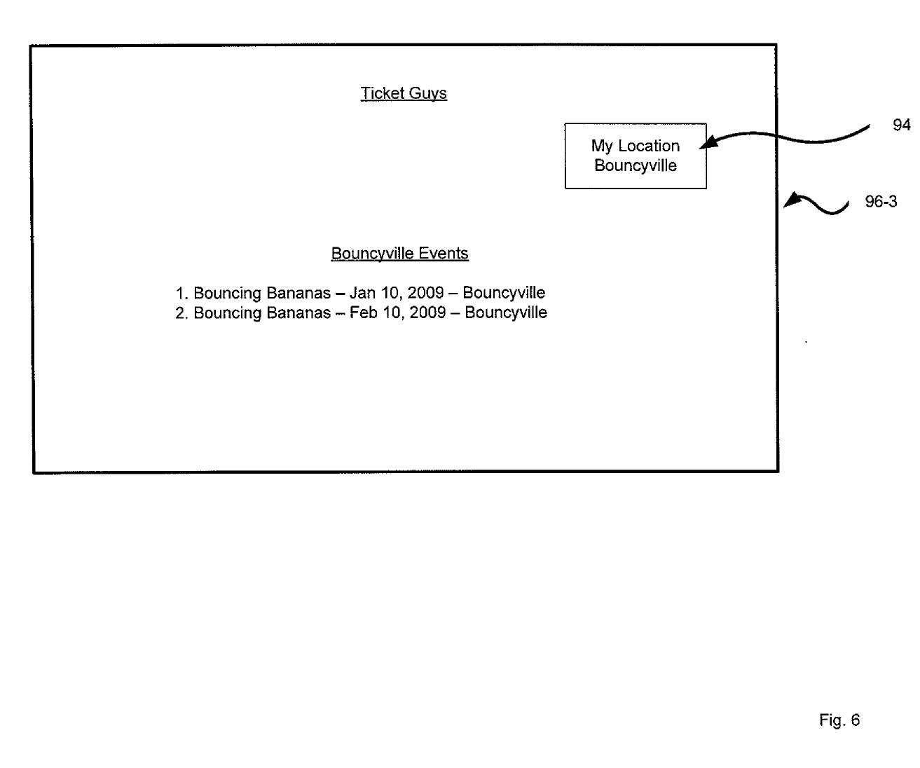

To help further explain the method 300, and system 50, a specific, simplified, but not-limiting example of website 90 is provided. FIG. 4, FIG. 5 and FIG. 6 show web pages 96-1, 96-2 and 96-3 from a hypothetical website 90 hosted on server 58 by an organization referred to as “Ticket Guys”. Website 90 is dedicated to providing event listings and selling tickets to events worldwide. Configuration options 94 for website 90 can be set to different locations throughout the world. FIG. 4, FIG. 5 and FIG. 6 represent how web pages 96 are generated on a traditional desktop browser, consistent with how they are programmed and stored on server 58. FIG. 4, FIG. 5 and FIG. 6 show different web pages as generated on a desktop browser based on the location that is provided for configuration options 94. More specifically, FIG. 4 corresponds to the configuration option 94 “Not Set”, which invokes web page 96-1 which lists events worldwide. FIG. 5 corresponds to the configuration option 94 “Hoppytown”, which invokes web page 96-2 which lists events only in Hoppytown. FIG. 6 corresponds to the configuration option 94 “Bouncyville”, which invokes web page 96-2 which lists events only in Bouncyville. Of note is that it is contemplated in this example that configuration options 94 on each of FIG. 4, FIG. 5, and FIG. 6 can be selected using a desktop browser using a pointing device to invoke java script or other dynamic HTML or other programming instructions associated with configuration options 94, in order to change the selected location. Thus, using a desktop browser, the first access of website 90 invokes web page 96-1 in FIG. 4. Configuration options 94 in FIG. 4 can then be selected using a desktop browser to invoke programming instructions that permit selection of another location and thereby update configuration options 94 and invoke another web page corresponding to the updated location. Such programming instructions for configuration options 94 can include a drop down box, or other selection tool, which can be used to provide input via the desktop browser signifying a new location and thereby update configuration options 94. The updated configuration options can then be stored in a cache so that subsequent access of website 90 leads directly to the web page that corresponded to the cached configuration option.

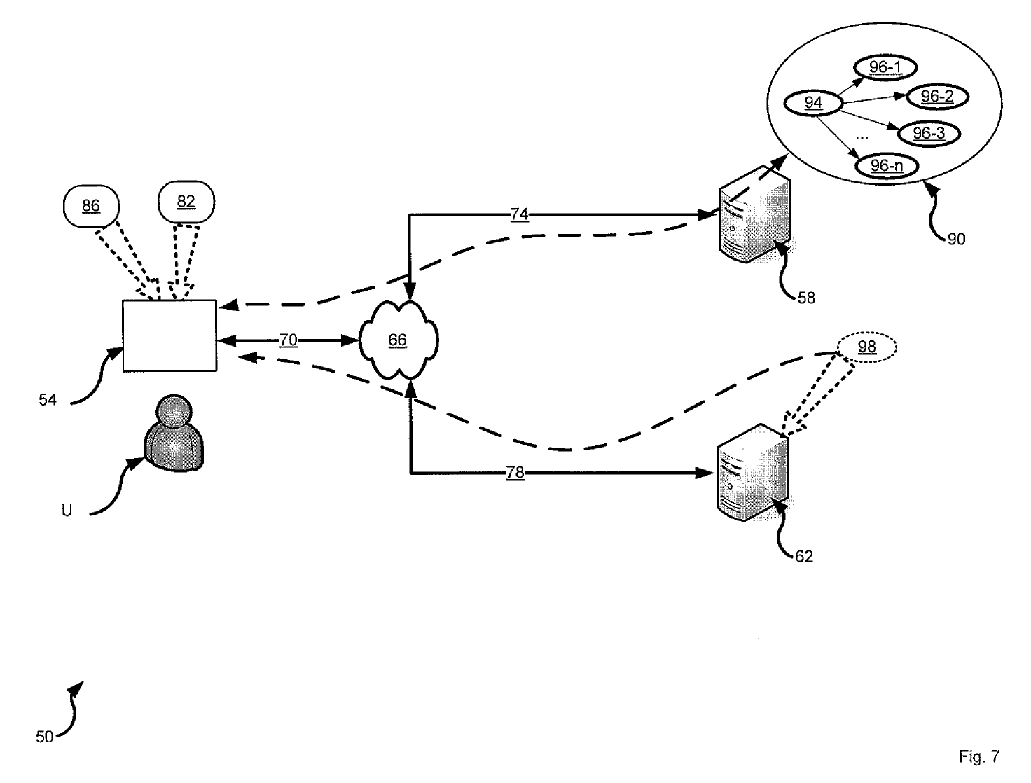

Block 310 comprises accessing a website. In system 50, block 310 is performed by client machine 54, which accesses website 90 via network 66 from server 58 in the usual manner. In a present embodiment, web browser application 82 accesses website 90 via network 66 from server 58 in the usual manner. Block 310 is represented in FIG. 7 as website 90 is shown as being accessed by client machine 54 using web browser application 82. The term “accessing” is non-limiting and can include, for example, opening a channel or the like so that client machine 54 can examine or retrieve portions of website 90, or can include retrieving all of website 90.

Block 315 comprises receiving a schema. In system 50, block 315 is performed by client machine 54 which receives schema 98 via network 66 from server 62. Block 315 is also represented in FIG. 7 as schema 98 is shown as being received by client machine 54 using web browser application 82. While “retrieving” is used in the present embodiment, “accessing” without actually downloading schema 98 is also contemplated. (Note that block 315 can be omitted where client machine 54 is configured to configured to parse website 90 and derive configuration options 94).

Block 330 comprises extracting configuration options from the website. In a present embodiment, client machine 54 utilizes schema 98 which points to configuration options 94 within website 90, or alternatively schema 98 substitutes configuration options 94 with a client machine configuration options 94. The client machine version of configuration options 94 obviates the java script or other DHTML or other scripting used to implement configuration options 94 on a desktop browser, and in this manner reduces consumption of computing resources on client machine 54, and at the same time obviates generation of data of web page 96-1 that is not required by client machine 54.

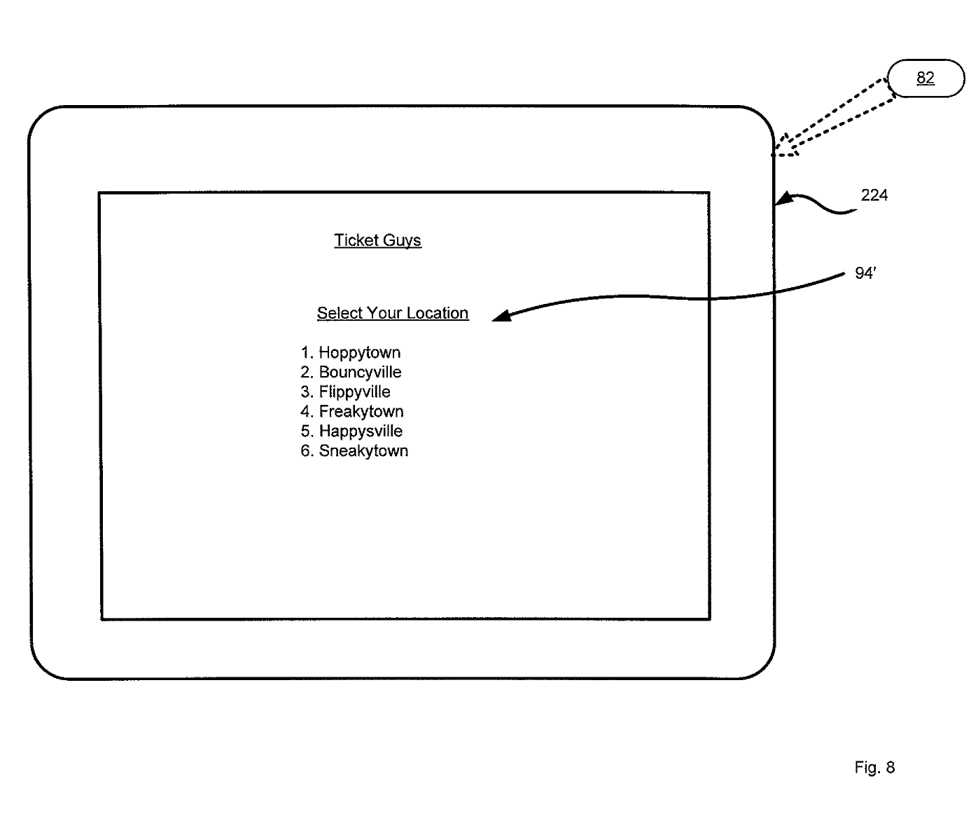

Block 335 comprises adjusting the website to generate configuration option selections. Block 335 is performed by client machine 54 which generates a configuration options screen that is native to client machine 54 and which is not otherwise part of website 90 as website 90 would be generated on a traditional desktop browser. Block 335 is represented in FIG. 8 as client machine configuration options 94′ are shown generated on display 224 of client machine 54. Client machine configuration options 94′ can be generated based on programming instructions, methods, or routines that are inherent to capabilities (e.g. the operating system or other programming objects) of client machine 54. Such programming instructions are configured to receive input that selects a configuration option, such as a standard menu application already inherently stored in non-volatile storage 212 of client machine 54.

Block 340 comprises receiving a configuration option selection. Block 340 is effected via configuration options 94′ from block 330. In the example shown in FIG. 8, any one of numbers one through six can be entered to select a location and thereby set the configuration option for website 90. In the present example, it will be assumed that “one” is selected, corresponding to the locale “Hoppytown”. While the specific example in FIG. 8 contemplates a menu selection via number entry, it is to be understood that other ways of setting location is contemplated. For example, another way of setting location is receiving input of a zip code or a postal code. Another way of setting location is receiving input of a city. Other ways are possible. Furthermore, while the example herein focuses on a configuration setting relating to locale, other configurations settings besides location are contemplated. Examples of other types of configuration settings include, without limitation, language; how many items are to be displayed; whether to display images; whether to show advertising; font; color of links, et cetera.

It will now be apparent that there are a broad range of configuration options depending on the website 90. For example, where website 90 is the popular Facebook® website, (www.facebook.com) a broad range of configuration options can be managed that are specific to Facebook®. Other non-limiting examples of configuration options can therefore include whether or not to display advertisements, location of images, location of data, colors, fonts, theme selection that is specific to a particular website.

Block 345 comprises receiving web pages corresponding to the selected configuration options. In the present example, since “Hoppytown” was selected at block 340, then web page 96-2 will be received at block 345. Again, the term “receive” can include either downloading from server 58, or from a cached version maintained locally on client machine 54.

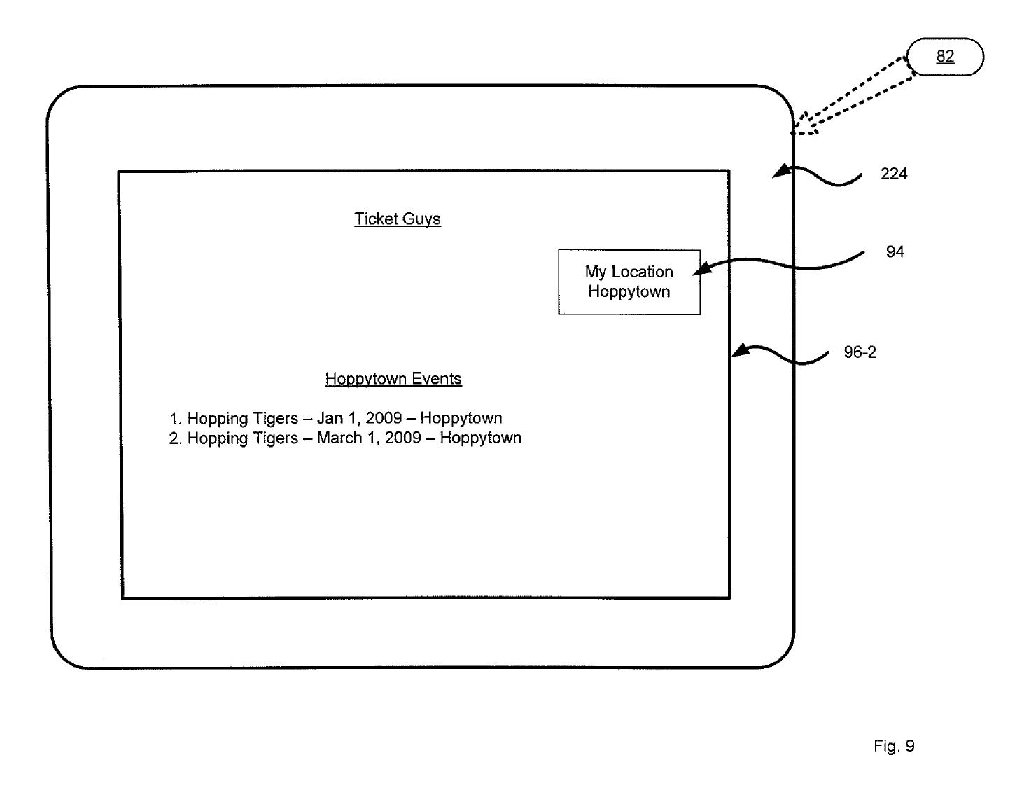

Block 350 comprises generating web pages received at block 345. Web browser application 82 thus generates web page 96-2, configuration options 94, (though generated in the form of the finally selected option) on display 224. FIG. 9 shows an example of web page 96-2 generated on display 224. In a present embodiment, web page 96-2 is generated in substantially the same form as it would be presented on a regular desktop browser, except that web page 96-2 itself is reduced in size in relation to a desktop monitor, in order to fit within the relatively smaller area of display 224. Client machine 54 and web browser application 82 are configured to receive selections of various portions of display 224, and if such selections are activated, then to “zoom in” on such selected portions on display 224 and cropping the non-selected portions of web page 96-2. Such functionality for web browser 82 is currently found in the web browser currently implemented in the BlackBerry Bold™ client machine from Research In Motion Inc. of Waterloo, Canada, though to be clear this is a non-limiting example, and this functionality is not required.

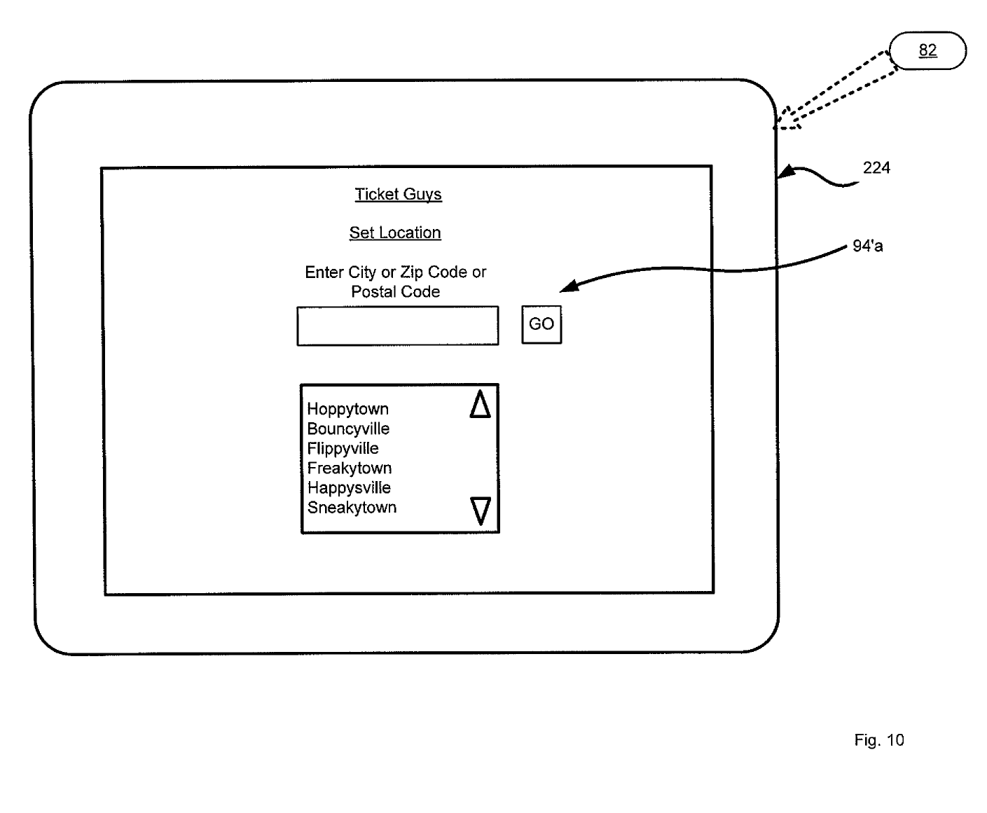

At this point method 300 ends, and web page 96-2 can be navigated in substantially the same manner as would be navigated using a desktop browser. As a variation, however, client machine 54 can be configured so that configuration options 94 are selected on display 224 as shown in FIG. 9, then the usual scripting associated with configuration options 94 as maintained on server 58 are ignored in favor of invoking configuration options 94′ in FIG. 8, and thereby further reduce stresses on computing resources of client machine 54. As a further variation, client machine 54 can be configured to receive input via keyboard 200 (e.g. a unique key sequence) or pointing device 202 in order to directly invoke configuration options 94′ in FIG. 8 during navigation of any page within website 90, including pages that do not include configuration options 94. As a further variation, the configuration option selected using configuration options 94′ can be stored in cache 86, so that during subsequent accessing of website 90 by client machine 54, blocks 310 through 340 can be omitted. As a further variation, schema 98 can be eliminated in favour of client machine 54 dynamically examining website 90 to extract configuration options 94 from configuration options 94 at the time that website 90 is first accessed by client machine 54. A still further variation is shown in FIG. 10, where an alternative to configuration options 94′ from FIG. 8 is shown as configuration options 94′a. In configuration options 94′a, a text entry box is provided that can receive typed text indicating the selected locale, either in the form of a zip code, postal code or city. FIG. 10 also shows a scrollable text list which shows various possible locales. Each item in the scrollable list can be selected, or the text from that list can be typed into the text entry box.

Various advantages will now be explained. Website 90 can be accessed and navigated on client machine 54 without programming changes to website 90. Further, such access and navigation on client machine 54 makes good use of computing resources on client machine 54. Further, bandwidth over links 70 and 74 is reduced as, in the present example, web page 96-1 is not ever loaded onto client machine 54. Bandwidth over links 70 and 74 is further reduced as client machine 54 need not make special calls or downloads for particular scripts which are too large to maintain on client machine 54, but which website 90 presumes are present on client machine 54.

These advantages address limitations that arise acutely when web pages are programmed with a focus on the desktop browsing experience, where Internet traffic bandwidth, computing processing resources, and screen area are less constrained than in the portable computing device mini-browsing experience. These web pages often do not render well on portable computing devices, which have access to less bandwidth than desktop wired devices, fewer processing and memory resources, and restricted screen sizes. Additionally, in desktop optimized web pages Javascript is liberally employed for such configuration settings, and yet support for Javascript may be limited on portable computing devices. Where a desktop browsing experience of a particular website involves navigation of a plurality of different web pages to provide different configuration option selection, the teachings herein transparently extract those configuration options and receive selections of those options so that configuration options can be selected without navigating the plurality of web pages contemplated in the desktop context.

Those skilled in the art are to understand that subsets, combinations and variations of the foregoing are contemplated. The claims attached hereto define the scope of the monopoly sought.

1. A portable computing device comprising:
storage configured to maintain a web browser application;
at least one processor connected to said storage and configured to execute said web browser application;
an interface connected to said processor;
said processor configured to access a website at a web-server via said interface;
said website including a first set of configuration option programming instructions;
said processor configured to extract configuration options from said first set of configuration option programming instructions;
a display connected to said processor; said processor further configured to generate said configuration options using a second set of configuration option programming instructions;
an input device connected to said processor; said processor configured to receive a configuration option selection using said second set of configuration option programming instructions via said input device;
said processor further configured to receive one or more web pages from said website corresponding to said configuration option selection; and,
said processor further configured to generate said one or more web pages on said display via said web browser application.

2. The portable computing device of claim 1 wherein said configuration options include at least one of a locale, how many items to display, whether to show images, font, or color.

3. The portable computing device of claim 1 wherein said extracting is based on a schema.

4. The portable computing device of claim 1 wherein said schema is received from a schema server separate from said server.

5. The portable computing device of claim 1 wherein said schema is received from said server.

6. The portable computing device of claim 1 wherein said first set of programming instructions comprises scripts.

7. The portable computing device of claim 1 wherein said scripts comprise one of Javascripts or dynamic hypertext markup language.

8. The portable computing device of claim 1 wherein said scripts are not stored locally on said portable computing device.

9. A method of providing interactive content on a portable computing device, the method comprising:
accessing, from an interface at said portable computing device, a website from a server connectable to said interface via a network; said website including a first set of configuration option programming instructions;
extracting, at a processor in said portable computing device and connected to said interface, configuration options from said first set of configuration option programming instructions;
generating, using said processor, said configuration options using a second set of configuration option programming instructions; said configuration options being generated on a display of said portable computing device and controlled by said processor;
receiving, from an input device of said portable computing device connected to said processor, a configuration option selection using said second set of configuration option programming instructions;
receiving, through said interface, one or more web pages from said website corresponding to said configuration option selection; and,
generating, using said processor, said one or more web pages on said display at said portable computing device.

10. The method of claim 9 wherein said configuration options include at least one of a locale, how many items to display, whether to show images, font, or color.

11. The method of claim 9 further comprising receiving a schema at said processor and performing said extracting based on said schema.

12. The method of claim 11 wherein said schema is received from a schema server separate from said server.

13. The method of claim 11 wherein said schema is received from said server.

14. The method of claim 9 wherein said first set of programming instructions comprises scripts.

15. The method of claim 14 wherein said scripts comprise one of Javascripts or dynamic hypertext markup language.

16. The method of claim 14 wherein said scripts are not stored locally on said portable computing device.

17. A computer readable storage medium configured to maintain a plurality of programming instructions for a processor of a portable computing device; said processor configured to execute said programming instructions; said programming instructions comprising the method of:
accessing a website from a server; said website including a first set of configuration option programming instructions;
extracting configuration options from said first set of configuration option programming instructions;
generating said configuration options using a second set of configuration option programming instructions;
receiving a configuration option selection using said second set of configuration option programming instructions;
receiving one or more web pages from said website corresponding to said configuration option selection; and,
generating said one or more web pages.

18. A system for providing interactive content on a portable computing device comprising:
at least one server configured to store a website and a schema; said website including a first set of configuration option programming instructions;
a portable computing device connectable to said at least one server via a network; said portable computing device comprising:
storage configured to maintain a web browser application;
at least one processor connected to said storage and configured to execute said web browser application;
an interface connected to said processor;
said processor configured to access said website at said server via said interface;
said processor configured to extract configuration options from said first set of configuration option programming instructions based on said schema;
a display connected to said processor; said processor further configured to generate said configuration options using a second set of configuration option programming instructions;
an input device connected to said processor; said processor configured to receive a configuration option selection using said second set of configuration option programming instructions via said input device;
said processor further configured to receive one or more web pages from said website corresponding to said configuration option selection; and,
said processor further configured to generate said one or more web pages on said display via said web browser application.

19. The system of claim 18 wherein said configuration options include at least one of a locale, how many items to display, whether to show images, font, or color.

20. The system of claim 18 wherein said at least one server comprises a web server for hosting said web pages and a schema server for hosting said schema.

21. The system of claim 18 wherein said first set of programming instructions comprises scripts.

22. The system of claim 18 wherein said scripts comprise one of Javascripts or dynamic hypertext markup language.

23. The system of claim 18 wherein said scripts are not stored locally on said portable computing device.
